(19) United States
(12) Patent Application Publication
(10) Pub. No.: US 2021/0361385 A1
(43) Pub. Date: Nov. 25, 2021

(54) Method for dental root treatment

(71) Applicant: Peter Wiechmann, Hannover (DE)

(72) Inventor: Peter Wiechmann, Hannover (DE)

(21) Appl. No.: 17/307,345

(22) Filed: May 4, 2021

(30) Foreign Application Priority Data
May 19, 2020 (DE) 10 2020 002 981.7

(51) Int. Cl. A61C 5/55

(52) U.S. Cl. CPC A61C 5/55

(57) ABSTRACT

A method is proposed for root treatment of a tooth, by which gutta percha is introduced into the root canal. For this purpose, a gutta percha point (6) is inserted into the root canal and is subjected to pressure and heat by a plugger (5). The gutta percha point (6) is prefabricated with a length that corresponds to the distance of the apex of the root canal from the tip of the plugger (5) inserted as far as possible into the root canal.

### RELATED APPLICATION

This application claims the benefit of priority from German Patent Application No. DE 10 2020 002 981.7, filed on May 19, 2020, the entirety of which is incorporated by reference.

### BACKGROUND

### Field of the Invention

The invention relates to a method for dental root treatment by introduction of gutta percha into the root canal, by which method the gutta percha in the root canal is subjected to pressure and heat by a plugger that generates pressure and heat.

### Description of the Related Art

A method of this kind is described in US 2004/0137404 A1, for example.

Such a method is used to preserve a tooth when the pulp of the tooth presents irreversible inflammation or necrosis. A known technique for this is, for example, the vertical compaction technique with warm gutta percha, hereinafter abbreviated to GP (kaltnermedia GmbH, Georg Thieme Verlag KG, Klinik and Praxis). In this technique, the root canal is filled with warm gutta percha, hereinafter abbreviated to GP, and with a sealing material designated as sealer.

To prepare for the method, the tooth pulp and in particular the root region of the tooth are cleaned mechanically and chemically. The cleaning serves to free the root canal system of all organic fractions and of substances and toxins having an antigen effect. The cleaning is performed using file systems, which are used in alternation with the known chemical solutions. The root canal is worked mechanically so that a continuously conical space is obtained. Finally, the whole space is cleaned chemically again and dried with alcohol and sterile paper points.

Once these preparations have been completed, a GP point equipped with a sealer and also designated as a master point is inserted into the root canal of the tooth and is advanced within the latter until it has reached the apex thereof (apical foramen) and cannot be advanced any further. Thereafter, the GP point is heated for a short period of time, for example 5 seconds, to a temperature of 200° C. for example, with a heat carrier. The GP point is then separated with the tip of the heat carrier above the apical region, and the separated part of the GP point is removed. Then, by means of a heating and pressure device also designated as a heat carrier and plugger, hereinafter referred to simply as plugger, the GP point remaining in the root canal is heated under application of pressure. In this way, the GP material and the sealer are intended to penetrate into all branches of the root canal system. After the plugger has been removed, the space remaining in the tooth is filled with GP. The separation of the GP point in the region above the apical region, after it has been heated, is often problematic, with the uncontrollable drawback that, on the one hand, the GP point is displaced from its position and in the process no longer reaches the apex of the root canal, and, on the other hand, the gutta percha is not completely removed from the middle and upper third of the root canal prior to the backfill with gutta percha.

US 2003/0219699 A1 discloses a metallic plugger which is provided with steps of different diameter and which is intended to be used when sealing a dental root canal. To seal the root canal, use is made of gutta percha which is introduced into the root canal. The plugger is intended to permit a rotation or compaction of the gutta percha.

U.S. Pat. No. 3,949,479 describes the customary treatment of a root canal of a tooth, with removal of the pulp and cleaning of the canal. The cleaned root canal is gradually filled with pieces of gutta percha, specifically in the first instance with a first cone which is compacted until it fills the space in the root canal. It is then followed by a second cone and further cone-like components.

U.S. Pat. No. 7,097,454 B1 discloses a GP point which is provided with markings and which is intended to be used for sealing in a root canal. The markings of the GP point ensure that the latter reaches as far as the apex of the root canal, such that no spaces remain in the latter.

DE 199 16 114 A1 describes a setting gauge or a tool that can be used as a root canal tool.

DE 20 2005 018 748 U1 discloses a probe for sealing the apical region of a dental root canal. It consists of a strand-shaped, flexible middle piece which has a predetermined breaking site and at the end of which a GP stopper with a plastic core is mounted. The probe can be inserted into a dental root canal and broken off at the predetermined breaking site. The GP stopper then remains in the root canal.

US 2004/0137404 A1, mentioned at the outset, is concerned with the sealing of a root canal of a tooth using a GP point. The GP point is inserted with a tool into a root canal and then separated in the root canal such that a length thereof remains in the lower region of the root canal. This length is separated at a predetermined site by means of a heated tool. Thereafter, compacting pressure is exerted on the separated length. A cover is then applied as a seal, for which a free space has been created in advance by removing material from the GP point.

### OBJECTS AND SUMMARY

The invention is intended to avoid inadequate filling of the root canal.

For this purpose, a method is used which is characterized in that,
first of all, a measurement distance lying between a reference point on the upper margin of the tooth and the apex of the root canal is measured,
thereafter, a plugger is inserted as far as possible into the root canal, and its measurement length lying between the reference point and its tip is measured,
after removal of the plugger, a gutta percha point is inserted into the root canal, the length of which gutta percha point is at least 1 mm greater than the difference between the measurement distance and the measurement length of the plugger, and which gutta percha point bears with its tip at the apex of the root canal, and
the gutta percha point is heated under pressure by means of the plugger inserted again into the root canal.

An important advantage of this method is that the root canal can be filled completely with GP, without having to remove GP material that has been inserted into the root canal during the method. The dimensions of the GP point that is to be inserted into the root canal are instead precisely set outside the tooth, prior to the insertion of the GP point into the root canal, such that the GP point precisely and completely fills the end of the root canal, at the apex thereof, and the plugger can be brought directly to the working position and set in operation.

To do this, following all the known and abovementioned measures, the measurement distance between the reference point and the apex of the root canal is first of all measured and documented or stored at a suitable location. Thereafter, a plugger of any desired kind, which should simply fit as closely as possible in the root canal, is pushed as far as possible into the root canal. Its measurement length is then measured and likewise documented. Thereafter, a GP point is produced with the length predefined by the difference between measurement distance and measurement length and is inserted into the root canal by means of a suitable tool until its tip bears on the apex of the root canal. After the tool has been removed, the plugger is inserted again into the root canal until it bears on the GP point. During its operation, the GP point is heated under pressure, as a result of which the required heating of the GP point and the required hydrostatic pressure are generated. The entire procedure can be monitored by X-ray. The GP and an optionally present sealer thus penetrate into all branches of the root canal. A time of approximately 3 to 5 seconds is needed for this. After the GP has sufficiently cooled, the plugger is removed and the remaining space of the tooth is filled with GP.

This method ensures that the apical region of the root canal is easily filled completely with GP and sealer before the application of pressure and heat. The tip of the GP point inserted into the apical region safely reaches the outermost tip of the apical region of the root canal. Undefined method steps and their disadvantages, in particular the separation of a GP point located in the root canal and the removal of the separated region, are thereby avoided.

The GP point inserted into the apical region of the root canal is approximately 1 mm longer than the previously measured and inserted plugger. This ensures that the heating of the inserted GP point can take place and the hydrostatic pressure for compacting the gutta percha in the root canal can be exerted. It is thus more certain that the root canal is filled with GP upon completion of the method.

After sufficient heating of the GP with the plugger, the delivery of heat is broken off. In order to maintain the pressure, the plugger remains in position until the GP has cooled. To remove the plugger from the tooth, the former is advantageously briefly heated again, such that it detaches from the filled GP without damaging the latter.

### BRIEF DESCRIPTION OF THE DRAWINGS

The method according to the invention is explained as an illustrative embodiment with reference to the drawings.

In the drawings:

FIGS. 1 to 3 show cross sections of a tooth in highly schematic representation, in different stages of the method.

FIG. 4 shows a tool used in the method.

Sections through a tooth are only shown purely schematically in the drawings. They serve only to explain the basic concept of the method according to the invention.

### DETAILED DESCRIPTION

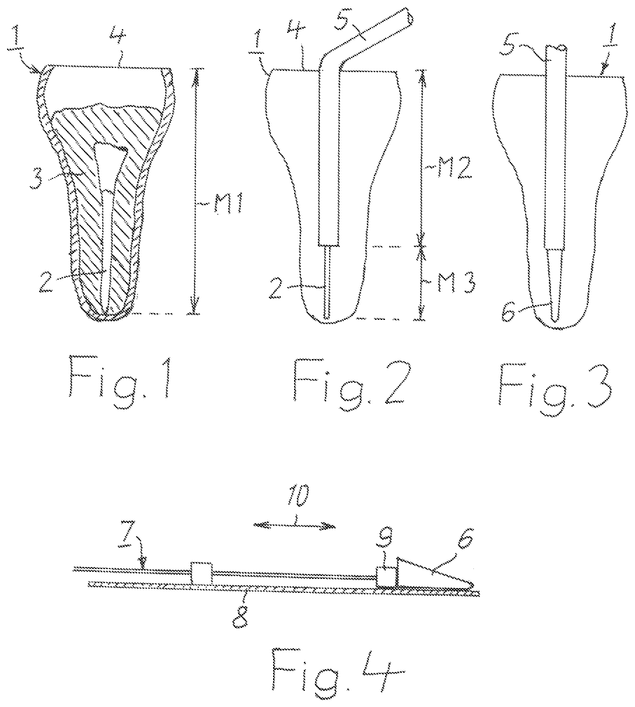

FIG. 1 shows, purely schematically, a cross section of an incisor 1 with only one root canal 2 (pulp), having a tooth body 3, designated as dentine, and enamel. At the start of the method, the tooth body 3 is first of all removed in the region of the crown. Thereafter, the root canal 2 is cleaned mechanically and chemically by a customary technique.

The distance between a reference point on the upper margin 4 of the tooth 1 and the apex of the root canal 2 is then measured as measurement distance M1. Thereafter, a plugger 5, which is attached to a source of electric current and can be heated by electric current, is pushed as far as possible into the root canal 2. The length between the reference point and the tip of the plugger 5 is then measured as measurement length M2 and recorded. The remaining length M3 of the root canal 2 corresponds to the receiving space for the GP point 6. It is prepared according to the length M3, specifically with an additional length of at least 1 mm. Thereafter, the GP point 6 is inserted into the root canal 2 by means of a tool 7.

The tool 7 is, for example, an elongate carrier 8 on which a slide 9 is arranged which is displaceable in its longitudinal direction and is displaceable in the direction of the double arrow 10. In the initial state, a contact face in which the GP point 6 can be arranged is present at the tip of the carrier 8. The carrier 8 can be, for example, a tube, which is equipped at its one end with the contact face.

To position the GP point 6 in the root canal 2, the carrier 8 equipped with the GP point 6 is inserted into said root canal 2, and the GP point 6 is pushed by means of the slide 9 until it has reached its predefined position according to FIG. 3. Thereafter, the carrier 8 is removed. The plugger 5 is then inserted again into the root canal 2 until it bears on the GP point 6. With the current source being switched on, the plugger 5 is then brought into the operating state, as a result of which the GP point 6 is heated under pressure, for example for 3 seconds, to a temperature of 100° C. After a predefined period of time, the heating is discontinued, while the pressure applied to the GP point 6 is maintained until the GP has cooled sufficiently. After the current source has been switched on for a very short time, the GP is pulled out for easy release of the plugger 5 from the root canal 2. The remaining space in the tooth 1 is then filled with GP by a customary technique.

1. A method for dental root treatment by introduction of gutta percha into the root canal, by which method the gutta percha in the root canal is subjected to pressure and heat by a plugger that generates pressure and heat, said method comprising the steps of:
first of all, a measurement distance lying between a reference point on the upper margin of the tooth and the apex of the root canal is measured,
thereafter, a plugger is inserted as far as possible into the root canal, and its measurement length lying between the reference point and its tip is measured,
after removal of the plugger, a gutta percha point is inserted into the root canal, the length of which gutta percha point is at least 1 mm greater than the difference between the measurement distance and the measurement length of the plugger, and which gutta percha point bears with its tip at the apex of the root canal, and
the gutta percha point is heated under pressure by means of the plugger inserted again into the root canal.

2. The method according to claim 1, wherein the heating of the plugger is switched off after a predefined period of time, while the pressure on the gutta percha point is maintained.

3. The method according to claim 1, wherein,
after sufficient cooling of the gutta percha point, the pressure applied to the latter by the plugger is cancelled and the gutta percha point is briefly heated, and
the gutta percha point is then removed.

4. The method according to claim 1, wherein a gutta percha point equipped with a sealer is used.

5. Method according to claim 1, wherein the gutta percha point is inserted using a tool equipped with a slide.

6. Method according to claim 1, wherein, after the plugger has been removed, the tooth is filled with gutta percha.
